(19) United States
(12) Patent Application Publication
(10) Pub. No.: US 2013/0115336 A1
(43) Pub. Date: May 9, 2013

(54) Extensively Hydrolyzed Rice Protein-Based Infant Formula and Use in Feeding Infants with Food Allergies

(71) Applicants: Jorge Luis Rosado Loria, Queretaro (MX); Miguel Angel Duarte-Vázquez, Queretaro (MX)

(72) Inventors: Jorge Luis Rosado Loria, Queretaro (MX); Miguel Angel Duarte-Vázquez, Queretaro (MX)

(73) Assignee: Nucitec, S.A. de C.V.

(21) Appl. No.: 13/630,911

(22) Filed: Sep. 28, 2012

(30) Foreign Application Priority Data
Sep. 29, 2011 (MX) MX/A/2011/010299

(51) Int. Cl. A23L 1/29

(52) U.S. Cl. CPC A23L 1/296
USPC 426/71; 426/590; 426/72; 426/598; 426/73

(57) ABSTRACT

An infant formula was developed. This formula was specially designed for infants with history of allergy to cow's milk proteins, Which normally occurs in infants fed with infant formula. The invention represents a novelty, because in addition to its unique composition, the formula of the invention is more effective than the formulas commonly used to address the problem of protein allergy, and also it contains substances that support a proper physical and mental development of the infant.

### FIELD OF THE INVENTION

The current invention is in the field of nutrition and special purpose infant formulas. More specifically, the invention is related to a feeding formula composition for children from 0 to 6 months old. This formula has more tolerability than cow milk protein-based formulas or soy-based formulas, and significantly decreases the adverse events produced by these formulas. More specifically, the composition of the invention is a new and improved food choice for children who exhibit cow's milk protein allergy or soy protein allergy.

### BACKGROUND OF THE INVENTION

For a long time has been recognized that the best food for newborns is breast milk. However, there are many situations where this is not possible and we have to use infant formulas which are preparations based on cow's milk. According to the National Nutrition Survey 2006, in Mexico 75% of the infants younger than four months were partly or fully fed with breast milk substitutes.

One of the problems associated with the increased consumption of infant formulas based in cow's milk protein is the high incidence of allergic reactions to such protein, which is expressed mainly in the form of Atopic Dermatitis (AD). In Mexico, for example, information provided by the Mexico Children Hospital reveal that about 6% of children younger than three years old are hypersensitive to proteins of cow's milk. The disease is associated with child discomfort, diarrhea, skin reactions, sleep disorders, irregular feeding, family stress, increased physician visits and a severe economic burden to families and the health care system. In fact, it is projected that healthcare systems could spend more than $1 billion USD per year in the treatment of atopic dermatitis and its complications. Of particular concern is that it has been shown that atopic dermatitis is associated with the development of asthma and allergic rhinitis in adults and infants.

In the last few years several formulas have been developed and used especially designed for feeding infants, in order to reduce the risk of allergies associated with consumption of protein from cow's milk, among which can be mentioned soy protein-based formulas, formulas based on extensively hydrolyzed protein, or in some cases elemental formulas based on free amino acids.

The allergenicity of a protein is defined as the ability of a given molecule to trigger an allergic reaction in sensitive individuals. Allergenicity depends on three factors:
a) a protein's molecular weight; a protein with molecular weight below to 2000 kDa is rare that motivates allergic reactions, however it is not the rule, b) the amino acid sequence, and c) space configuration. The last two factors determine the appearance of epitopes (a limited part of the molecule to which the IgE antibody or lymphocyte receptor binds), with higher molecular weight greater number of epitopes.

In order to reduce the allergenicity of a protein, its molecular weight must be reduced, thereby decreasing the number of potential epitopes. This can be achieved by hydrolyzing the protein with heat or enzymatic procedures. When a protein is heated, the disappearance of conformational epitopes is induced.

Hydrolyzed formulas are considered to have a high degree of hydrolysis and therefore they are hypoallergenic if the molecular weight of the residual peptides does not exceed 2,000 Da. These formulas can be used to feed an infant with cow's milk protein allergy, with some assurance that undesirable reaction will not occur. (Alexander and Cabana, J Pediatr Gastroenterol Nutr. 50(4):422-30 (2010)).

U.S. Pat. No. 5,405,637 describes a partially hydrolyzed milk protein obtained by enzymatic methods and an infant formula containing the same. The enzymatic process produced a protein with a degree of hydrolysis between 4 and 10%, which significantly reduced the antigenicity of the protein.

The enzymatic hydrolysis of the cow's milk protein reduces its allergenic potential by reducing the molecular weight of the resulting peptides. However, its nutritional profile is not intended to be used as routine formula in healthy infants, since does not contain other components that are present in breast milk and are essential for proper physical and mental development, such as docosahexaenoic acid (DHA) arachidonic acid (ARA) and nucleotides, among others, limiting its range of application and use for prolonged ingestion. Additionally, extensively hydrolyzed cow's milk protein. which is considered safe and effective in children allergic to cow's milk proteins, may contain residual peptides, therefore hypersensitivity reactions at such proteins can occur in about 2% of subjects (American Academy of Pediatrics Committee on Nutrition. Hypoallergenic infant formulas, Pediatrics, 106:346-349 (2000)). Additionally, the bitter taste characteristic of these formulas and its poor acceptance may be cause for rejection by the infants.

Also free amino acids-based elemental formulas have been developed (McLeish et al., Arch Dis Child. 1995 September; 73(3):211-5; Sicherer et al., J Pediatr. 2001 May; 138(5):688-93 2001; U.S. Pat. No. 6,645,543 B), however broadly application is limited because they are very expensive and have a very unpleasant taste thereby decreasing acceptance.

A possible alternative for this population is the use of soy-based formulas. Soy is cheaper and has greater acceptance than extensively hydrolyzed formulas or amino acids-based formulas. The energy content of soy-based formulas and extensively hydrolyzed is very similar and both meet the nutritional requirements of the infants. Kohler et al. (Acta Paediatr Scand. 1984 January; 73(1):40-8) demonstrated that when healthy infants fed soy-based formulas, these experienced similar growth to those fed with milk formula. Despite these advantages, between 10 and 35% of infants who are allergic to milk protein, have some type of intolerance to soy proteins (Savilathi et al., 1989). More recently, it was shown that the prevalence of allergy to soy protein in infants with milk protein allergy was 14% (Klemola et al., J Pediatr. 2002 February; 140(2):219-24).

Moreover, some recent publications have recommended that soy protein-based formulas should not be used in children younger than 6 months with some type of food allergy, therefore the use of these formulas is very limited (ESPGHAN Committee on Nutrition, 2006; Bohles et al., Pediatr Allergy Immunol. 2006 March; 17(2):112-7). Infants who are allergic to milk proteins, and are also intolerant to soy-based formulas, need to consume other protein sources. In these cases, an option could be hydrolyzed soy protein, but its use in the long term might produce nutritional imbalance (Donzelli et al., Pediatr Med Chir. 1990 January-February; 12(1):71-9).

### SUMMARY OF THE INVENTION

The present invention is directed to an infant composition characterized by comprising for each 100 mL of the reconstituted formulation an energy content of about 60 to about 80 kcal, more preferably about 70 kcal; about 1.5 to about 4 g of protein, more preferably about 1.8 g; from about 6 to about 16 g of carbohydrate, more preferably about 7.5 g; and from about 3 to about 8 g of fat, more preferably about 163 g. The compositions of the invention have greater tolerability than milk-based formulas or soy based formulas.

In one aspect, the protein employed in the composition is hydrolyzed rice protein; the carbohydrate is selected from the group consisting of sugar, corn starch, rice starch, maltodextrin, non-digestible oligosaccharides, and mixtures thereof; included in the fat portion are long chain polyunsaturated fatty acids (LC PUFAs). Additionally, the composition further comprises nucleotides, vitamins, minerals, inositol, choline, taurine and carnitine. The hydrolyzed rice protein can by a protein preparation wherein more than 80% of the rice protein hydrolyzate comprising peptides have a molecular weight of 5 kilodaltons or less.

One object of the invention, is to obtain a nutritional composition for use as a feed or infant formula in children aged 0-12 months, which has greater tolerance than existing formulas and also significantly reduces adverse events produced with formulas based on cow's milk protein or soy based-formulas.

Another object is to develop a nutritional composition for use in the feeding children allergic to milk or soy protein, and at the same time serve as a sole source of nutrition.

Another object is to develop a nutrient composition that in addition to providing the aforementioned benefits, having a suitable composition of nutrients and beneficial substances to ensure good physical and mental development.

### BRIEF DESCRIPTION OF THE DRAWING

FIG. 1 depicts the results of the clinical study described In Example 2. Clinical tolerance to CMP and/or elemental formula (baseline), is compared to clinical tolerance of an HRF formula of the invention.

### DESCRIPTION OF THE INVENTION

It is well know n that the best way to feed a newborn is administering its own mother's milk. In many cases this is not possible, and the baby should be fed with a formula derived from suitably modified cow's milk.

One problems associated with an increase in consumption of cow's milk protein based infant formula is the high incidence of allergic reactions to such protein.

To have appropriate interventions for prevention and treatment of this type of allergy is highly important in public health, since the disease is associated with child distress, diarrhea, skin reactions, sleep disorders, irregular feeding, family stress, increase visits to the doctor and a very strong economic burden for families and health care system.

One aspect of the present invention is directed to obtaining and using a nutritional formula that significantly decreases the disadvantages and negative effects that currently occur with the use of infant formulas, especially those designed for feeding infants who have allergies to cow's milk proteins and soy proteins. In addition, the product of the present invention properly maintains the growth and development of infants.

The main disadvantage of the formulas found in the prior art lies in their unsuitable flavor and low acceptability degree as a result of the hydrolysis process, and they may also have traces of un-hydrolyzed peptides which represent a risk for the occurrence of allergic reactions.

The formula of the invention is especially designed based on rice protein with high hydrolysis degree, which has proven to be well tolerated by infants diagnosed with any type of allergy, including allergic to cow's milk proteins, to extensively hydrolyzed milk protein, to soy protein and hydrolyzed soy protein. Furthermore, the flavor of the hydrolyzed rice protein is more pleasant than any other currently available hydrolyzed.

Moreover, a careful analysis of the formulas currently on the market shows that the nutritional profile of such products is limited in certain nutrients that are essential for proper physical and mental development of the child such as DHA (docosahexaenoic acid) for brain development, ARA (arachidonic acid) for the development of the cornea, linolenic acid which is precursor of DHA, taurine which is an essential amino acid in the first 6 months of life. Nucleotides that are positively involved in fat metabolism and intestinal function and its deficiency can produce undesirable effects on a child's development, so another advantage of the formula of the invention resides in the composition of nutrients present, since it was specifically designed to emulate as close as possible to breast milk and thereby ensure the proper development of the infant.

Certain differing properties of the composition of the invention are the following:
a) The formula contains hydrolyzed rice protein supplemented with some amino acids such as L-lysine and L-tryptophan to reach an amino acid profile similar to that found in human milk. The hydrolyzed rice protein has a greater tolerability in children with allergy to other foods, besides an adequate nutritional quality.
b) The incidence of allergenic response is associated with a delay in the maturation of the immune response mechanisms during childhood. The intestinal flora is part of a complex ecosystem, which has great influence on the postnatal development of the immune system, therefore the stimulation of such flora with prebiotics can be an effective method to positively alter the immune system. The formula is supplemented with prebiotics which stimulate the growth of beneficial bacteria in the digestive, inducing a positive effect on the infant's immune response. It is known that human milk contains neutral oligosaccharides that are an important factor in promoting the development of the intestinal flora and are found in a proportion of 90% galactooligosaccharides (GOS) and 10% fructooligosaccharides (FOS). For this reason the formula of the invention is supplemented with 0.8 g/100 ml of a mixture of FOS and GOS in the same proportions as in human milk (10:90).
c) The composition of the present invention is enriched with long chain polyunsaturated fatty acids, (LC PUFAs), particularly DHA (docosahexaenoic acid) and ARA (arachidonic acid), which are essential for an adequate development of brain and nervous system as well as the optimal retinal development in infants. Some of these compounds are included only in a few infant formulas currently used. The composition of the invention has a DHA content of between 60 to 100 mg/100 g of formula, while the ARA is present at a concentration of between 100 to 200 mg/100 g of powdered formula.
d) The composition of the invention is enriched with nucleotides in the following proportions:
Adenosine monophosphate (AMP) 3.2 mg/100 g
Cytidine monophosphate (CMP) 12.0 mg/100 g
Guanosine monophosphate (GMP) 2.5 mg/100 g
Inosine monophosphate (IMP) 1.0 mg/100 g
Uridine monophosphate (UMP) 1.35 g/100 g

Nucleotides are non-protein nitrogen compounds which are part of the structure of DNA and RNA and therefore are essential for growth and various biochemical processes involved in cellular metabolism. Human milk provides nucleotides and is believed that in periods of rapid growth, exogenous nucleotides can save endogenous metabolic production and promote immunity. Studies conducted in infants that were fed infant formula supplemented with nucleotides showed a lower incidence of infectious diarrhea, enhanced immune response to vaccines and in the case of low birth weight, the growth is improved.
e) Another important modification included within the composition relates with the reduction of lactose content, since this may contain a small amount of serum proteins which can trigger any type of allergic reaction.

### EXAMPLE 1

Preparation of an Infant Formula Composition

| | | | | | Amount per | |
|---|---|---|---|---|---|---|
| | | | | | serving size | |
| | Amount per | | | | (water 90 mL + | |
| | 100 g | | | | 14.5 g | |
| | powdered | | Amount | | powdered | |
| Nutrient | formula | Unit | per 100 kcal | Units | formula) | Units |
| Energy | 2032.80 | kJ | 420 | kJ | 294.76 | kJ |
| | 484.00 | kcal | 100 | Kcal | 70.18 | kcal |
| Protein | 12.80 | g | 2.64 | G | 1.86 | g |
| Fat | 25.10 | g | 5.19 | g | 3.64 | g |
| Saturated fat | 4.69 | g | 0.97 | g | 0.68 | g |
| Polyunsaturated fat | 4.26 | g | 0.88 | g | 0.62 | g |
| Linoleic acid | 3.85 | g | 0.80 | g | 0.56 | g |
| Linolenic acid | 225.00 | mg | 46.49 | mg | 32.63 | mg |
| Docosahexaenoic acid | 56.00 | mg | 11.57 | mg | 8.12 | mg |
| (DHA) | | | | | | |
| Arachidonic acid | 56.00 | mg | 11.57 | mg | 8.12 | mg |
| (ARA) | | | | | | |
| Carbohydrates | 51.73 | g | 10.69 | g | 7.50 | g |
| Sugars | 3.85 | g | 0.80 | g | 0.56 | g |
| galactooligosaccharides | 4.79 | g | 0.99 | g | 0.69 | g |
| fructooligosaccharides | 0.53 | g | 0.11 | g | 0.08 | g |
| Dietary Fiber | 0.00 | g | 0.00 | g | 0.00 | g |
| Sodium | 220.00 | mg | 45.45 | mg | 31.90 | mg |
| Vitamin A | 1732.50 | IU | 357.95 | IU | 251.21 | IU |
| Vitamin D | 296.00 | IU | 61.16 | IU | 42.92 | IU |
| Vitamin E | 8.20 | IU | 1.69 | IU | 1.19 | IU |
| Vitamin K | 40.00 | μg | 8.26 | μg | 5.80 | μg |
| Vitamin (ascorbic | 49.00 | mg | 10.12 | mg | 7.11 | mg |
| acid) | | | | | | |
| Vitamin B₁ (thiamine) | 550.00 | μg | 113.64 | μg | 79.75 | μg |
| Vitamin B₂ (riboflavin) | 740.00 | μg | 152.89 | μg | 107.30 | μg |
| Vitamin B₆ | 400.00 | μg | 82.64 | μg | 58.00 | μg |
| (pyridoxine) | | | | | | |
| Vitamin B₁₂ | 1.50 | μg | 0.31 | μg | 0.22 | μg |
| (cobalamin) | | | | | | |
| Folic Acid | 44.00 | μg | 9.09 | μg | 6.38 | μg |
| Niacin | 7.50 | mg | 1.55 | mg | 1.09 | mg |
| Biotin | 9.90 | μg | 2.05 | μg | 1.44 | μg |
| Pantothenic acid | 2.80 | mg | 0.58 | mg | 0.41 | mg |
| Choline | 49.00 | mg | 10.12 | mg | 7.11 | mg |
| Inositol | 25.00 | mg | 5.17 | mg | 3.63 | mg |
| Potasium | 500.00 | mg | 103.31 | mg | 72.50 | mg |
| Chloride | 338.20 | mg | 69.88 | mg | 49.04 | mg |
| Calcium | 400.00 | mg | 82.64 | mg | 58.00 | mg |
| Phosphorus | 255.00 | mg | 52.69 | mg | 36.98 | mg |
| Iron | 7.50 | mg | 1.55 | mg | 1.09 | mg |
| Magnesium | 59.00 | mg | 12.19 | mg | 8.56 | mg |
| Zinc | 4.90 | mg | 1.01 | mg | 0.71 | mg |
| Manganese | 35.00 | μg | 7.23 | μg | 5.08 | μg |
| Copper | 400.00 | μg | 82.64 | μg | 58.00 | μg |
| Iodine | 74.00 | μg | 15.29 | μg | 10.73 | μg |
| Selenium | 17.00 | μg | 3.51 | μg | 2.47 | μg |
| Chromium | 20.00 | μg | 4.13 | μg | 2.90 | μg |
| Molybdenum | 20.00 | μg | 4.13 | μg | 2.90 | μg |
| Taurine | 33.00 | mg | 6.82 | mg | 4.79 | mg |
| Carnitine | 9.80 | mg | 2.02 | mg | 1.42 | mg |
| Nucleotides | 24.10 | mg | 4.98 | mg | 3.49 | mg |
| AMP | 4.98 | mg | 1.03 | mg | 0.72 | mg |
| CMP | 8.31 | mg | 1.72 | mg | 1.20 | mg |
| GMP | 1.66 | mg | 0.34 | mg | 0.24 | mg |
| IMP | 3.32 | mg | 0.69 | mg | 0.48 | mg |
| UMP | 5.78 | mg | 1.19 | mg | 0.84 | mg |
| L-triptophan | 90.00 | mg | 18.60 | mg | 13.05 | mg |
| L-lysine | 120.00 | mg | 24.79 | mg | 17.40 | mg |

Proper preparation is obtained by mixing 14.5 g of powder with enough water to achieve a final volume of 100 mL. This gives a protein concentration of 1.86 g/100 ml, similar to that found in breast milk.

The protein source used here is hydrolyzed rice protein, in which more than 80% of the residual peptides have molecular weights below 5 kDa. The protein sources used contribute approximately 10% of the total energy.

The carbohydrates in the formula provide 43% of the total energy and are composed of sucrose, maltodextrin, fructo and oligosaccharides.

Fats provide 47% of the total energy. The sources of fat used in the composition of the invention include corn oil and soybean oil, among others.

The composition is enriched with amino acids that are found in low proportions in rice protein, such amino acids are L-lysine and L-tryptophan.

### EXAMPLE 2

### Clinical Study of Infant Formula

Clinical tolerance of the new hydrolyzed rice formula (HRF) was study in Eighteen infants (seven boys and eleven girls, mean age 5.3 months, range 1.1-14.1 months) diagnosed with cow's milk allergy. Patients enrolled in the study had to be intolerant to extensively hydrolyzed cow's milk protein and/or amino acid-based elemental formula.

Clinical tolerance to the formula products was tested, by the evaluation of the appearance of the characteristic symptoms of of allergy to cow's milk allergy such as anaphylaxis, laryngeal stridor, labial oedema, rhinitis, asthma, rash and vomiting who had developed clinical reactions (mainly diarrhea and eczema. Follow-up was at 3 and 6 months.

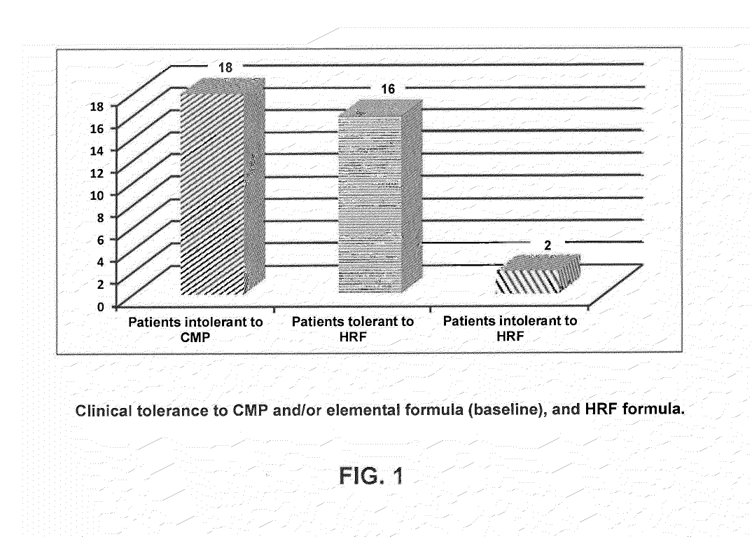

One infant showed immediate allergy reaction to HRF hydrolyzed rice formula. Two infants did not become tolerant to HRF during the study, while growth parameters were in the normal range (FIG. 1).

In accordance with current guidelines, this HRF was tolerated by almost 90% of children with CMP allergy and therefore could provide an adequate and safe alternative to CMP-hydrolyzed formulas for these infants.

The invention has been described sufficiently to allow a person skilled in the art to reproduce and obtain the results stated herein. However, any person skilled in the technical field of the present invention may be able to make modifications not described in this application, however, if for the application of such modifications in a determined structure or in the process of manufacturing thereof is required matter claimed in the following claims, such structures must be within the scope of the invention.

Having adequately described the invention, it is considered as a novelty and therefore it is claimed as property the statement contained in the following clauses claiming.

We claim:

1. An infant composition characterized by comprising for each 100 mL of the reconstituted formulation
An energy content of about 60 to about 80 kcal, more preferably about 70 kcal;
About 1.5 to about 4 g of protein, more preferably about 1.8 g;
from about 6 to about 16 g of carbohydrate, more preferably about 7.5 g; and
from about 3 to about 8 g of fat, more preferably about 3.63 g.

2. The composition of claim 1, wherein the composition of the invention has greater tolerability than milk-based formulas or soy-based formulas.

3. The composition of claim 1, wherein:
said protein is hydrolyzed rice protein;
said carbohydrate is selected from the group consisting of sugar, corn starch, rice starch, maltodextrin, non-digestible oligosaccharides, and mixtures thereof;
said fat comprises long chain polyunsaturated fatty acids (LC PUFAs),
and wherein said composition further comprises nucleotides, vitamins, minerals, inositol, choline, taurine and carnitine.

4. The composition of claim 1, characterized because it contains hydrolyzed rice protein.

5. The composition of claim 4, wherein more than 80% of the rice protein hydrolyzate comprising peptides have a molecular weight of 5 kilodaltons or less.

6. The composition of the invention according to claim 3, which is enriched with non-digestible oligosaccharides which have prebiotic activity.

7. The composition according to claim 6, wherein the prebiotic oligosaccharides are fructo-oligosaccharides and galacto-oligosaccharides.

8. The composition of claim 7, wherein fructo-oligosaccharides are in a concentration from about 0.05 to about 0.20 g per 100 kcal, more preferably about 0.110 g/100 kcal.

9. The composition of claim 7, wherein the galacto-oligosaccharides are at a concentration ranging from about 0.1 and about 10 g per 100 kcal, more preferably about 0.98 g per 100 kcal.

10. The composition of the current invention according to claim 3, which is enriched with long chain polyunsaturated fatty acid (LC PUFAs), especially DHA (docosahexaenoic acid) and ARA (arachidonic acid).

11. The composition according to claim 10, wherein the DHA is found in a range concentration from about 30 to about 100 mg per 100 g of formulation, more preferably about 56 mg/100 g of formula.

12. The composition according to claim 10, wherein the ARA is found in a range concentration from about 30 to about 100 mg per 100 g of formulation, more preferably about 56 mg/100 g of formula.

13. The composition according to claim 3, which is enriched with a mixture of nucleotides in a range of concentration from about 5 mg to about 50 mg per 100 grams of powder formula, more preferably about 24.1 mg/100 g of powder formula.

14. The composition according to claim 13, wherein the mixture of nucleotides is formed as follows:
Adenosine monophosphate (AMP) from about 1 mg to about 15 mg/100 g of powdered formula, more preferably about 3.2 mg/100 grams of formula.
Cytidine monophosphate (CMP) from about 5 to about 30 mg/100 grams of powdered formula, preferably about 12 mg/100 grams per 100 grams of formula.
Guanosine monophosphate (GMP) between about 1 mg and about 10 mg per 100 grams of powdered formula, preferably about 2.5 mg per 100 grams of formula.
Inosine monophosphate between about 1 mg and about 10 mg per 100 grams of powdered formula, more preferably about 1.0 mg per 100 mg of formulation.
Uridine monophosphate from about 1 mg to about 15 mg per 100 grams of powdered formula, more preferably about 1.75 mg per 100 grams of formula.

15. A composition according to claim 3, wherein the vitamins and minerals are selected from sodium, potassium, calcium, phosphorus, chlorine, magnesium, manganese, iron, copper, zinc, selenium, iodine, vitamin A, C, D, E, K, all the B complex vitamins (B1, B2, B6 and B12), niacin, pantothenic acid, and mixtures thereof.

16. The composition according to claim 3, which is supplemented with inositol at concentrations ranging from about 10 to about 100 mg per 100 grams of powder formula, more preferably about 25 mg per 100 g of powder formula.

17. The composition according to claim 3, which is supplemented with choline at concentrations from about 10 to about 100 mg per 100 grams of formula, more preferably about 49 mg per 100 g of formula.

18. The composition according to claim 3, which is supplemented with taurine at concentrations from about 10 to about 100 mg per 100 grams of formula, more preferably about 33 mg per 100 g of formula.

19. The composition according to claim 3, which is supplemented with carnitine at concentrations from about 1 to about 50 mg per 100 grams of formula, more preferably about 10 mg per 100 g of formula.

20. The composition of claim 3 which is fortified with L-lysine at concentrations from about 50 to about 300 mg of L-lysine per 100 g of formula most preferably about 120 mg of L-lysine per 100 g of formula.

21. The composition of claim 3, which is supplemented with L-tryptophan at concentrations from about 40 to about 200 mg of L-tryptophan per 100 grams of formula, more preferably about 90 mg of L-tryptophan per 100 g of formula.

22. The composition according to claim 1 wherein the end product can be a powder that must be mixed with water before use or where the final product may be presented as a sterile liquid ready to use.
